(19) United States
(12) Patent Application Publication
(10) Pub. No.: US 2003/0094369 A1
(43) Pub. Date: May 22, 2003

(54) Method of simultaneously concentrating and separating analytes

(75) Inventors: H. Dennis Tolley, Mapleton, UT (US); Qinggang Wang, Provo, UT (US); Milton L. Lee, Pleasant Grove, UT (US); David A. LeFebre, Camino, CA (US)

Correspondence Address: GREER, BURNS & CRAIN, 300 S WACKER DR, 25TH FLOOR, CHICAGO, IL, 60606, US

(73) Assignee: Brigham Young University

(21) Appl. No.: 10/260,898

(22) Filed: Sep. 30, 2002

Related U.S. Application Data
(60) Provisional application No. 60/326,383, filed on Oct. 1, 2001.

(51) Int. Cl. G01N 27/26

(52) U.S. Cl. 204/450; 204/545; 204/547

(57) ABSTRACT

A method and apparatus are disclosed for simultaneously concentrating and separating a plurality of analytes which includes generating a continuous electric field gradient within an enclosed passageway, and where the electric field gradient is characterized by the graph of the gradient with respect to position along the length of the axis of the passageway being a non-linear, monotone, non-decreasing function with a non-increasing first derivative. Analytes entrained in a carrier fluid within the passageway are exposed simultaneously to the continuous electrical field gradient and an opposing force selected for exerting a force on the analytes. The analytes are allowed to reach equilibrium with respect to the continuous electric field gradient and the opposing force, then are released in a controlled manner to maintain separation. The unique shape of the electric field intensity curve allows for simultaneous concentration and separation of analytes.

### BACKGROUND

The present invention relates to the separation of analyte species in a carrier fluid sample. More specifically, it relates to a method of simultaneously concentrating and separating analytes in a particular order.

Analytical separations are essential in modern chemistry. Of particular interest at this time is the separation of proteins that originate from samples of body fluids. Diagnosis or treatment of diseases may be accomplished by the detection of specific proteins, or perhaps by an imbalance in specific types of proteins. The presence or absence of a particular chemical species may signal the development of a disease or condition years before physical symptoms are present. When detected and treated at such an early stage, diseases such as cancer, are more easily treated, or perhaps, prevented from developing fully. Separation of complex protein mixtures is a major challenge in modern analytical chemistry.

A well-known method for separation of analytes using an electrical potential is known as electrophoresis. When a potential difference is introduced across immersed electrodes, suspended or colloidal particles migrate toward electrodes of the charge opposite that of the particles. Proteins act like colloidal particles and their charge is positive or negative depending on the properties of the proteins and the surrounding solution. The acidity of the solution can be used to control the direction in which a protein moves upon electrophoresis.

One known method for separating proteins is by equilibrium gradient separation. In an equilibrium gradient separation, the net force on each analyte species is a result of by a combination of forces. The net force decreases monotonically along the direction of the force, and more importantly, changes direction at some point in the separation channel. Thus, wherever an analyte species is placed inside the channel, the net force will draw it to its equilibrium point where the force is zero. Relative changes between the forces allow the equilibrium positions to shift, allowing the analytes to move out of the separation channel one by one in order of some property of the analyte. Where electrophoresis is conducted with a changing electrical field and with an opposing force, an equilibrium gradient separation is obtained.

Unlike, linear separation techniques such as chromatography or electrophoresis, steady state bands are formed when equilibrium is reached in an equilibrium gradient separation. Based on how the force gradient is formed, equilibrium gradient methods can be classified into two categories, constant field and field gradient. In constant field focusing, a constant external field is combined with a gradient in some property, such as pH or density, to exert a force gradient on the analyte. Examples include density gradient sedimentation and isoelectric focusing. In the field gradient category, the force gradient results directly from a gradient in the external field or combination of fields. Since a field gradient is not always easy to form, methods in this category have not developed as quickly.

The equilibrium gradient separation has advantages over other separation techniques because it is based on equilibrium between forces. The effects of diffusion, and other forces that tend to scatter the concentrated species, are minimized because any force that tends to push the analyte out of its equilibrium position is opposed by either of the opposing forces. All forces on the analytes are balanced at equilibrium and do not act to defeat the separation, allowing the analytes to be narrowly focused in a region about the equilibrium point. There is reduced dependence on good injection techniques since the shape of the equilibrium band is independent of the injection. This technique also makes it easy to separate multiple analytes at once.

Where an electric field gradient is combined with an opposing liquid flow (e.g. hydrodynamic or electroosmotic force), the equilibrium gradient separation is known as electromobility focusing (“EMF”) or field gradient focusing. EMF is known as a technique for separating a multi-component charged analyte mixture. In U.S. Pat. No. 5,298,143, Ivory et al. disclose an apparatus for separating proteins. An array of electrodes is used to create a series of discrete zones that vary the electrical field along the length of a column. The electrode array is dynamically programmable, meaning that the output from each electrode can be modified at any time during a run.

As taught in the above-referenced patent, when a sample enters the column, the field gradient is linear, having a steep slope. As equilibrium is reached between the movement of ions due hydrodynamic forces and the opposing electrical field, the analytes tend to become focused in a narrow band. Ivory then centers the band by modifying the electrical field, changing the balance between the opposing forces and allowing the analytes to move in a desired direction. After centering, the field gradient is reduced so that the graph of the gradient has a lower slope. In this environment, the analytes will spread out according to their electrophoretic mobilities for ease in separation.

Ivory's apparatus is very versatile due to its ability to dynamically change the shape and intensity of the electrical field. Depending upon the complexity of the analyte mixture, Ivory increases or decreases the electrical field along the length of the column as needed to resolve analytes, move components or isolate an impurity. This versatility is due in part to the multi-electrode apparatus, but also to this method of operating it whereby information from the concentration step is used to determine the characteristics of the electrical field for the separation step. Determination of the electrical field gradient for improvement of separation is made only after information from previous focusing is available. Thus, Ivory teaches that the separation is facilitated using information from prior focusing steps.

### SUMMARY OF THE INVENTION

The present method of concentrating and separating a plurality of analytes overcomes a number of the problems identified above.

More specifically, a method and apparatus for simultaneously concentrating and separating a plurality of analytes includes generating a continuous electric field gradient within a passageway enclosed to the analytes, where the electric field gradient is characterized by the graph of the gradient with respect to position along the length of the axis of the passageway being a non-linear, monotone, non-decreasing function with a non-increasing first derivative. Analytes entrained in a carrier fluid within the passageway are exposed simultaneously to the continuous electrical field gradient and an opposing force, the opposing force being selected for exerting a force on the analyte. The analytes are allowed to approach or reach equilibrium with respect to the continuous electric field gradient and the opposing force, and then are released in a controlled manner to maintain separation. The unique shape of the electric field intensity curve allows for simultaneous concentration and separation of analytes not seen in the prior art.

The present invention has several advantages over Ivory. Because no feedback is necessary, this method of concentrating and separating analytes is amenable to preprogramming a continuous or stepwise method to obtain concentration and separation simultaneously. By merely changing the voltage differential across the same passageway, the electric field is altered in the same relative manner and the curve retains the same general shape. Multiple voltage changes over a period of time produce a family of similarly shaped curves, each having a different amplitude. The ability to preprogram the separation process allows it to be easily automated, reducing the labor required to process samples.

Automation of the process makes it easily amenable to multi-dimensional separations. Many analytical tools, including chromatography, mass spectrometry and capillary electrophoresis, are more successful when the analytes are at higher concentrations and where there is some separation between species. The use of equilibrium gradient separation concentrates and separates the analytes for more reliable examination and/or identification.

### BRIEF DESCRIPTION OF THE DRAWINGS

FIG. 1 shows one embodiment of an apparatus for analyte separation by electromobility focusing;

FIG. 2 shows an example graph of the electric field intensity with respect to position in the passageway of the example;

FIG. 3A shows a distributed resistor for creating an electric field gradient;

FIG. 3B shows a second embodiment of a passageway having an electric field gradient using the distributed resistor of FIG. 3A;

FIG. 4 shows a third embodiment of a passageway having a continuously changing cross-sectional area;

FIG. 5 is a detail schematic diagram of the ion migration across the semi-permeable, hollow fiber membrane used in FIG. 1;

FIG. 6 shows bands of concentrated analyte that form in the passageway;

FIG. 7 shows a family of the graphs as in FIG. 2 resulting from changing voltage differential; and

FIG. 8 shows the separation of BSA and Mb using electromobility focusing using the apparatus of FIG. 1.

### DESCRIPTION OF THE INVENTION

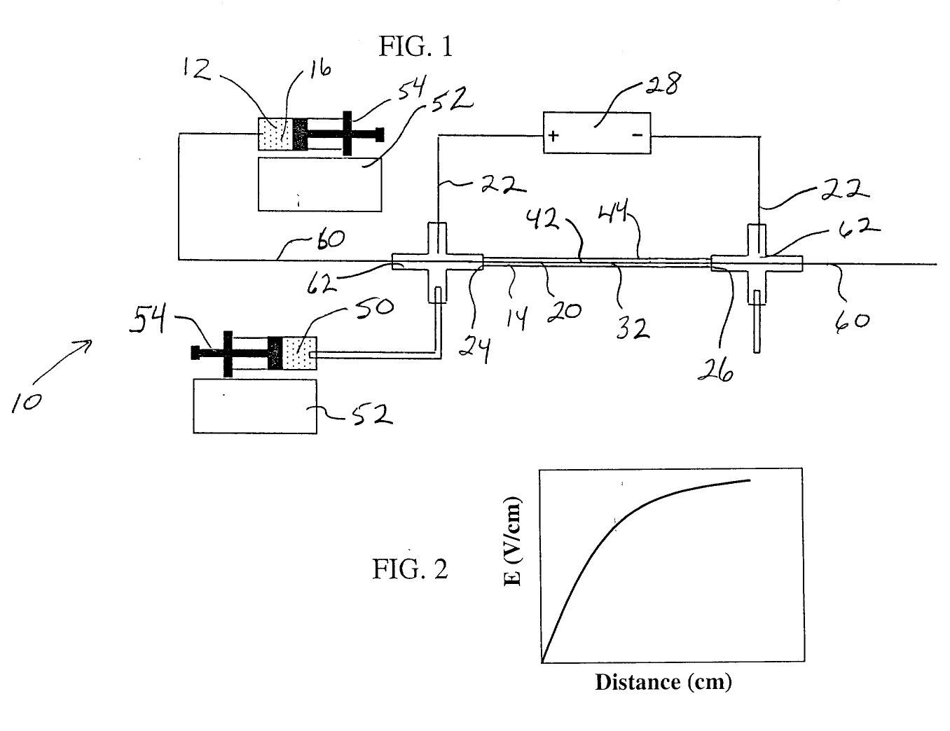

Referring to FIG. 1, this method and apparatus, generally designated 10 are useful for separating a number of analytes 12 by balancing an electric field gradient with an opposing force in an enclosed passageway 14. Particles and chemical species from biological and environmental fields are of particular interest.

In the biological field, this technique is useful to separate proteins, lipoproteins, nucleic acids, peptides, carbohydrates, ionic chemicals or any other analytes 12 of interest. Of particular interest are samples from fields of in human health, medical practice, clinical diagnosis, biochemistry and the life sciences. Separation of proteins, for example, may be used to identify markers characteristic of a disease or condition. Small particles, such as cells, subcellular organelles, microparticles, nanoparticles and other particles smaller than 100 micrometers in diameter can also be concentrated and/or separated using this technique.

Although the biochemical field is of specific interest, electrical field gradient methods are useful in a number of other applications as well. Any ionic chemicals or small charged particles less than 100 micrometers in diameter can be concentrated and/or separated by this method. The use of this technique on materials for environmental analysis, for example carboxylic acids, amines, etc. is also contemplated.

The analyte 12 sample is placed in a carrier fluid 16 prior to entry into the passageway 14. Any fluid 16 is suitable that dissolves the analyte, maintains a charge on the analyte in solution, flows through the channel and permits formation of an electric field gradient within it. Liquids are the preferred fluids. The fluid 16 may include only a single chemical compound, or it may be made up of a mixture of a plurality of fluids. Water, acetonitrile, methanol or any of a variety of organic solvents are useful carrier fluids 16. Additives are optionally added to the fluid to enhance particular properties. Salts or other electrolytes are suitable to enhance the electrical conductivity of the fluid and to have diffusion of ions to generate the gradient. The concentration range of salts of about 0.1 millimolar to about a molar molar are preferred. Polymers, such as polyethylene oxides, polyacrylamides, cellulose derivatives, are optionally added to help improve solubility, reduce adsorption, decrease dispersion. Additives to modify the pH are also useful. Aqueous buffer solutions having a pH range of from about 2 to about 12 are more preferred carrier fluids, such as those prepared with acids and bases. An aqueous solution of Tris-HCl is a suitable carrier fluid. The analyte sample 12 is introduced into the carrier fluid by injecting it with a syringe, using a valve, a pump or through the use of any suitable fluid dispensing device.

The electric field gradient is established along the enclosed passageway 14. The passageway 14 need not have a particular shape, geometry or size to be useful in this invention, but has an entry port and an exit port located such that one of the opposing forces acts to move the analytes toward the entry port and at least one of the other forces acts to move the analytes toward the exit port. A simple cylindrical tube or channel is very effective.

At least a portion of the passageway 14 preferably includes a membrane 20 that is impenetrable by the analytes 12. The analytes 12 move on one side of the membrane known as the gradient channel 42, while the remaining fluid also flows in the remainder of the passageway 14 known as the purge channel 44. The membrane 20 keeps the analytes 12 serves to confine the analytes, to provide conductivity between the purge channel and the gradient channel, also from becoming too dilute in the widest portion of the passageway. Although the equilibrium forces would eventually bring the analytes 12 to an equilibrium position, the analytes are more quickly focused if they are kept in the main stream of the passageway 14. Any semi-permeable membrane 20 having an appropriate pore size is suitable.

At least two electrodes 22 are submerged in the fluid such that the passageway 14 is located between the electrodes. The electrodes are connected to a voltage source 28. It is contemplated that several EMF devices could be used in series, even having common electrodes. However, between each pair of electrodes the electric field gradient is continuous

Passageways having a relatively small width or diameter are preferred. The larger the width of the passageway 14, (where the width is measured perpendicular to the direction of the electrical force) the longer it takes to establish equilibrium and less precise focusing may be obtained in a reasonable amount of time. Microchannel technology is contemplated as being useful to produce passageways for this process. Any microfabrication techniques typically used in microfluidic devices are useful here. It is also envisioned that a plurality or array of passageways, such as but not limited to microchannels, be used in parallel to process large numbers of samples at high speed. Passageways 14 with a rectangular cross section are preferably approximately from about 5 microns wide to about 1 cm in width and from about 5 microns to about 1 mm deep. Tubular passageways are preferably about 5 microns to about 1 mm in diameter.

For ease of discussion, the analytes are assumed to enter the passageway at the entry port 22. However, it is contemplated that the analytes could enter the passageway at any point along its length. An injection port could be located, for example, in the middle of the passageway 14 or at the exit port 24. Due to the equilibrium nature of the process, the analytes 12 will seek the point where the net force is zero, regardless of where they enter the passageway 14.

The passageway 14 may be packed with particles or filled with inorganic or organic monolithic material along a portion of its length, or its entire length. Spherical silica or any particulates used in chromatography are examples of useful particles. The analytes within the passageway 14 are exposed simultaneously to at least two opposing forces, each of which is selected for exerting a force on the analyte. Electrical forces are preferred for charged analytes that will move in an electrical field. Hydrodynamic forces, the forces produced by fluid flow, are also very useful. Gravitational, centrifugal, magnetic, thermal, acoustic, electroosmotic or electromagnetic forces are also contemplated as being useful as the opposing force. Combinations of forces are also useful, such as a concentration gradient used to produce the electric field gradient and used to oppose hydrodynamic forces.

Appropriate equipment is needed to generate the opposing force or forces as will be appreciated by an artisan. Pumps, valves and other equipment to generate flow of fluids are used to generate hydrodynamic forces. Equipment known to produce sound is used to generate acoustic forces. Gravitational or centrifugal forces are generally produced in a centrifuge. Magnetic or electromagnetic forces are generated by magnets. The increase or decrease in heat, for example by heat lamp, convection or submersion in a hot or cold bath, creates thermal forces. The equipment used to generate the forces is controlled, and the forces modified as is known in the art.

The order in which the components are separated depends upon the analytes and the opposing forces used together with the electrical field gradient. Where hydrodynamic forces oppose the electric field, the analytes are sorted by their electrophoretic mobilities in a specialized field gradient separation known as electromobility focusing.

The gradient utilized in the present invention is characterized by the graph of the field Intensity with respect to position along the length of the axis of the passageway 14 being a non-linear, monotone, non-decreasing function with a non-increasing first derivative. FIG. 2 shows an example of a graph of the field intensity gradient that meets the above criteria. The shape of this curve is important in order to simultaneously concentrate and separate the analytes 12. Because the function is non-decreasing, the field strength is always lowest at the entry port to the passageway, either constant or increasing along the length and strongest at the exit. The non-increasing first derivative ensures that the slope of the function is always steepest at the entry port, then decreases or remains constant along the length, with no inflection points.

Concentration or focusing of the analytes 12 occurs in the passageway 14 where the change in the field gradient is the steepest. A rapidly changing field strength focuses many analytes 12 in a relatively narrow distance. As the slope of the gradient decreases, i.e. the curve flattens out, the analytes become better separated. Those analytes 12 having electrophoretic mobilities of the largest magnitude move closest to the exit of the passageway 14 before reaching equilibrium. Reduction in the gradient slope allows the equilibrium bands to spread further apart compared to the initial steep slope. The greatest separation is achieved as the slope approaches zero, however, the equilibrium band is broadest. Thus, the exact slope that is desirable approaching the exit of the passageway is a balance between the peak separation and the peak width.

Several methods of creating an electric field gradient are known. Any technique that is able to generate the electric field gradient profile described above is useful in the present invention. Use of distributed resistors 30, varying the cross-sectional area of the passageway 14 and the use of porous membranes or hollow dialysis fibers 32 are particularly useful in generating the field gradient.

Distributed or contoured resistors 30 provide local variations in the electric field by varying parameters of the resistor along its length. Any feature of the resistor 30 that changes the local electric field can be used, for example composition, density, or geometry. Changes in composition include, but are not limited to sequential use of materials of different resistivity or patterned deposition of materials with different resistivity. The thickness of the resistive material can also vary.

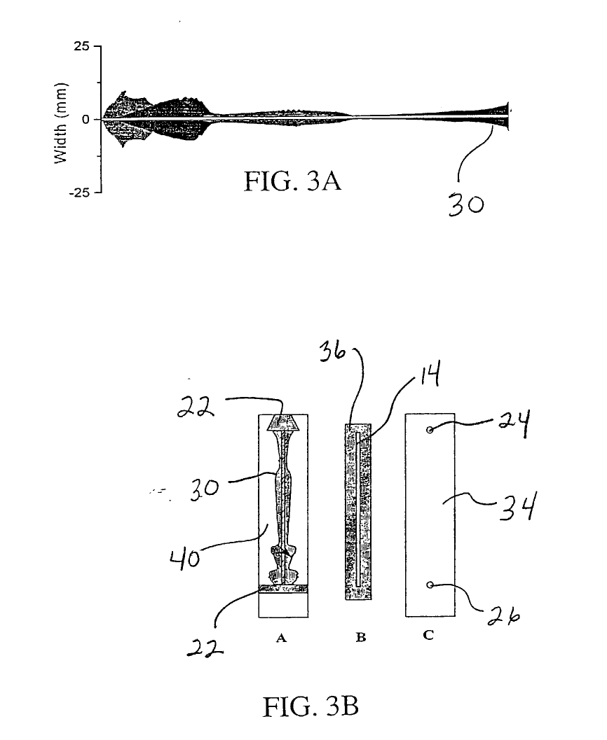

The distributed resistor 30 shown in FIG. 3A utilizes at least four distinct materials and changing geometry to continuously vary the resistance-between 10 KΩ and 100 MΩ. The contours are drawn on a refractory substrate using a plotting process having multiple pens such as the OHMCRAFT MICROPEN made by Ohmcraft of Honeoye Falls, N.Y. Each line drawn represents a single resistance, however, to get a desired resistance usually requires that at least two inks with different resistivities be blended on top of each other to achieve a smooth resistance gradient between lines. A conventional multi-color ink jet print head is also useful to deposit inks of different resistivities to produce the x-axis resistance gradient. Diffusion between the lines helps to smooth the resistance profile in the x-axis.

FIG. 3B shows an apparatus for utilizing the distributed resistor 30 in the present invention. A base plate 34 has openings for the entry port 24 and the exit port 26. A spacer plate 36 provides a thickness for the passageway 14. The distributed resistor 30 is printed on a substrate 40. The spacer plate 36 is sandwiched between the base plate 34 and the substrate 40, forming the passageway 14 between them. The carrier fluid 16 and analytes 12 enter the passageway 14 through the entry port, travels the length of the passageway along the distributed resistor which changes the local electric field intensity, then leaves through the exit port 26 in the base plate 34.

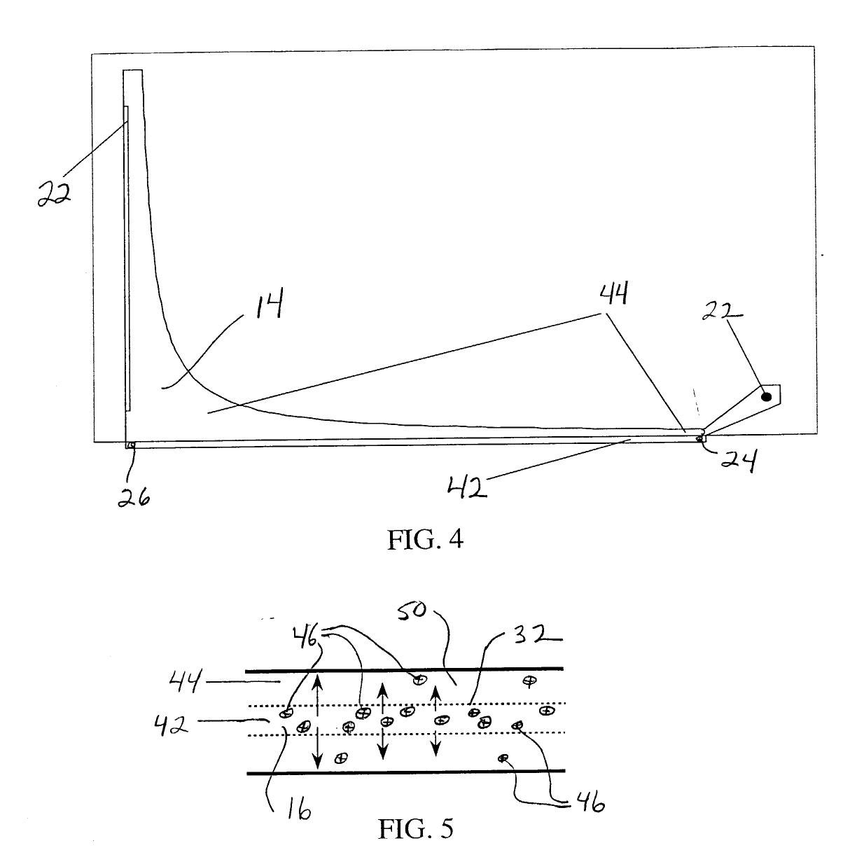

Variation in the electrical field gradient can also be accomplished by changing the cross sectional area of the passageway 14. One embodiment for achieving this is shown in FIG. 4. The fluid 16 flows through the passageway 14, which is a shaped cavity within a transparent block. Analytes 12 are confined to a gradient channel 42, but a purge channel 44 changes in cross-sectional area from the entry port 24 to the exit port 26. When the fluid 16 first enters the passageway 14, the resistance is very low because the cross sectional area of the passageway is relatively high. As the fluid 16 moves through the passageway 14, the cross section continuously decreases. Since the strength of the electric field varies with the cross sectional area, a field intensity gradient is formed along the length of the passageway 14.

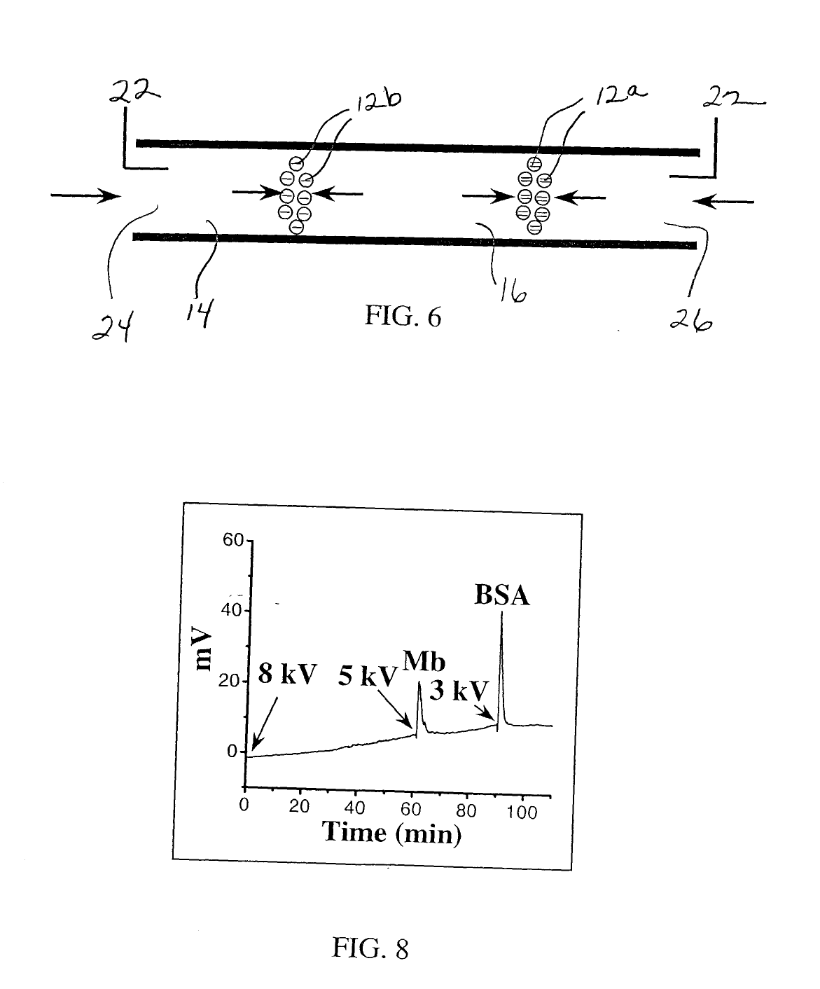

A third embodiment for creating an electric field gradient is through use of a semi-permeable membrane 32 with an ionic concentration gradient. A suitable membrane, such as a dialysis fiber, is used along at least a portion of the passageway 14 that is parallel to the direction of flow. FIG. 5 shows a schematic diagram of the ion flow through the membrane. The field gradient is generated by means of an ionic solution. The ions 46 and the membrane 32 are selected so that the analytes 12 will not pass through the membrane, but the ions are able to flow freely from one side of the membrane to the other. Any barrier that has pore sizes that will not allow passage of the analytes, but allows passage of the electrolyte ions can be used. The fluid 16 in the gradient channel 42 is an ionic solution having a high relative concentration of ions 46. Purge fluid 50 on the other side of the membrane 32, the purge channel 44, has a low relative concentration of ions 46, encouraging flow of ions from the gradient channel 42 to the purge channel. As the fluid flows along the membrane 32, the concentration of ions on the gradient channel 42 decreases, producing local variations in the electric field intensity.

One particularly preferred apparatus 10 utilizes a coaxial dialysis fiber 32 as the gradient channel 42, within and surrounded by the purge channel 44, so that the low concentration purge fluid 50 flowing around the fiber, as shown in FIG. 1. As the analytes 12 move, the ions 46 flow outward from the fiber 32 and are carried out of the passageway 14 by the purge fluid 50 in the purge channel 44, and creating an ionic gradient along the length of the passageway, causing local variation in the electric field strength.

Combinations of more than two forces are also useful in this invention. In the discussion below, electromobility focusing is discussed as one specific embodiment of this invention. However, it is contemplated that other forces be utilized in place or in addition to the hydrodynamic forces used herein.

The analyte sample 12 is introduced into the passageway 14 by any known method. Because the analytes 12 are concentrated and focused prior to exit from the passageway, the accuracy or methodology of introducing one of more or the analytes is less important than in other separation techniques. Any dispersion of the sample or other inaccuracies of the sampling process is counteracted by action of the opposing forces to draw the analytes together.

FIG. 6 shows bands of concentrated analyte that form in the passageway. Once the sample is present in the passageway 14 and the opposing forces are applied, the analyte sample 12 is allowed to reach equilibrium with respect to the continuous electric field gradient, represented by the left-pointing arrows, and the opposing force, represented by the right-pointing arrows. Since the electric field strength is lowest at the entry port to the passageway, the analytes 12 will initially move toward the passageway exit. Those analytes 12a with electrophoretic mobilities of the largest magnitude will move closest to the passageway exit. At some point, the force of the electrical field balances with the opposing force, such that the net force on the analyte 12 is zero. The analytes 12a, 12b stop and is concentrated until the balance of the forces changes.

It is important to choose the opposing force and the relative strengths of both the opposing force and the electrical field so that the analytes 12 of interest reach an equilibrium point within the passageway 14. Hydrodynamic and electrical forces are preferred forces because both are variable over a wide range using a minimal amount of equipment. Choice of a steep electric field gradient provides a wide range of field strengths, increasing the probability of finding an equilibrium point over the length of the passageway 14. Where information is known as to the mobility of at least one of the analytes 12, the slope of the gradient is optionally selected to optimize the degree of concentration and separation of the analytes. An example of a steep electric field gradient is one of more than 10 V/cm².

At equilibrium, a number of analytes 12 are concentrated in the steep portion of the curve, while those with the largest electrophoretic mobility magnitudes are more separated toward the exit of the passageway. After the analytes 12 are focused in the passageway 14, the remaining analytes nearest the exit are released in a controlled manner to maintain separation. This is done by changing the intensity of one of the forces continuously or in a series of steps, preferably automatically. As the balance of forces change, the analytes 12 move toward the exit of the passageway and those the largest mobility magnitudes are removed from the passageway 14.

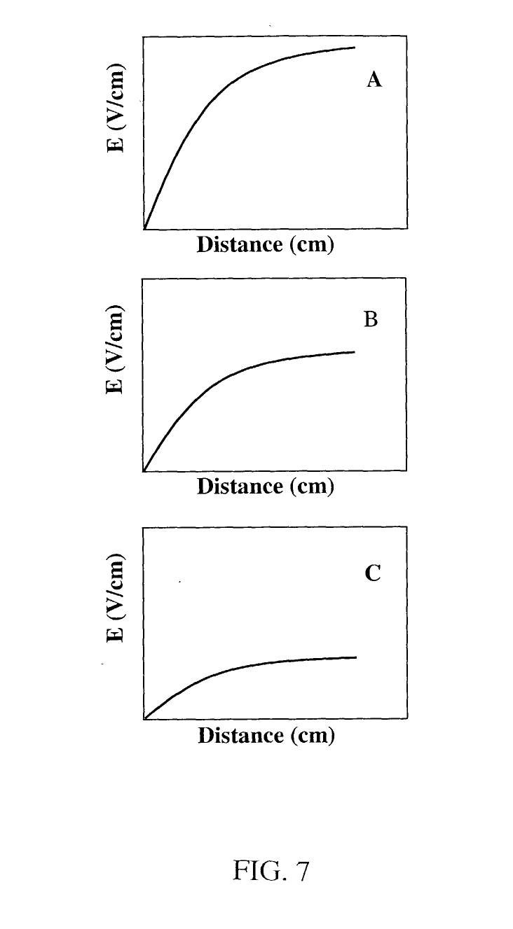

At each voltage drop, a curve is generated that is a non-linear, monotone, non-decreasing function with a non-increasing first derivative. The general shape of the field gradient curve remains the same, but it is moved toward the X-axis and the slope is proportionately reduced at all points along the curve. FIG. 7 shows a family of curves where the voltage differential decreases between graph A and graph B, then again between graph B and graph C. As equilibrium attempts to reestablish, the analytes with the largest magnitude mobilities 12 move toward the separation zone and spread out. This sequence of decreasing voltage drop and reestablishing equilibrium is then repeated until all of the analytes 12 have been eluted from the passageway 14. Electrical differentials of up to 50 kV are preferably used in this process. Preferably, the initial voltage differential is from about 6 kV to about 20 kV. Voltage reduction is done in a series of steps depending upon the number of analytes being separated, the span of electrophoretic mobilities that are expected and the type of analytes 12 being separated. Preferably, the voltage changes range from about 1 V to about 1 KV in a sequential decrease. More preferably, the voltage is reduced from about 1 KV to about 4 KV per decrease. The voltage need not be reduced the same amount each time.

It is also to be understood that the method and the apparatus of this invention is useful when the change in forces is done in a continuous fashion. Under these circumstances, equilibrium is not actually reached, but the analytes continuously move as the forces are continuously changed. For example, continuous changes in the voltage differential of from about 1 V/min to about 1000 V/min are useful for separating the analytes of interest. Continuous change in the net force is applicable to any opposing forces. Although several parts of the discussion are directed to a series of steps in changing forces, use of continuous changes are applicable to any embodiment of this invention.

Automation of this process is attained by programming the series of decreasing voltage drops to sequentially concentrate and separate a number of analytes in order of their electrophoretic mobilities without the need for in vivo feedback. No feedback is needed to center the focused analytes 12 or to space the peaks to individually separate the species. The steep initial curve focuses most of the analytes 12 together. Sequential lowering of the voltage differential in small steps or continuously gradually lowers the curve, spreading out all of the species, but particularly allowing those with the largest magnitude electrophoretic mobility to be separated in the shallow portion of the field gradient curve and to move toward the exit port. By dropping the overall voltage just as the analytes approach equilibrium, a continuous stream of separated analytes are removed from the passageway. The shallow portion of the curve preferably has a slope of less than 1 V/cm², while the steep portion of the curve preferably has a slope greater than 10 V/cm².

The automated method is controlled by any known means for process control. Computers or dedicated controllers, either analog or digital, are useful for this purpose. Preferably the process is controlled by a personal computer, or equivalent device, preprogrammed to change parameters as needed to effect the separations. Any parameter that establishes the balance between the forces and the position of the resulting band of analytes is subject to control. The field intensity of the electrical field is decreased periodically or continuously during electromobility focusing by decreasing the voltage differential over the passageway. In this embodiment, the computer would be programmed to allow the analytes 12 to reach equilibrium, then decrease the voltage differential by a predetermined increment. The analytes 12 are again allowed to migrate to their new positions due to the change in forces and the voltage differential is again decreased.

Nearing or reaching equilibrium could be determined by analytical means or by waiting a preprogrammed amount of time. Reaching or nearing equilibrium when the process first begins is likely to take more time than when the voltage differential is changed later in the process. All of the analyte species 12 move toward their equilibrium positions and order themselves according to their electromobilities. When subsequent changes to the voltage differential are made, the analytes 12 are already aligned in order and have less distance to travel. The initial time allowed for establishing equilibrium is preferably from about 5 minutes to 150 minutes. More preferably, the time is programmed to allow from about 10 minutes to about 50 minutes. With subsequent decreases in the voltage drop, the time allowed for equilibration is preferably from about 1 minutes to 30 minutes, and more preferably from about 1 minutes to about 15 minutes.

If the concentration of individual analytes 12 is small, it is optionally useful to concentrate the analytes from a large sample or several small samples into a small volume of fluid prior to analysis, identification or further use. Using the focusing step for an extended time period, a sample is injected into the fluid and allowed to approach equilibrium. Analytes 12 from the total accumulated sample will also be focused together, while excess carrier fluid flows out of the passageway 14. As long as the forces remain in place, the equilibrium will remain in place and the analytes 12 will stay focused. When the analytes 12 are sufficiently concentrated, they can then be released, either individually or as a group for further use.

This technique is particularly useful when the analytes 12 are to be analyzed, examined or identified by an analytical method that requires a minimum concentration not met by the sample alone. Several samples are combined using the concentration step. The resulting analytes 12 are then released at a rate that is optimum for the particular analytical method. Mass spectrometry is an example of a method of analysis that benefits from concentration of the sample. Sample fluid is collected and concentrated until an optimum analyte concentration is obtained. The analytes 12 are then sequentially released to the mass spectrometer for identification and/or determination of additional properties.

The simultaneous concentration and separation of analytes 12 is also useful as one portion of a multi-dimensional separation. Analytical separations; such as mass spectrometry, electrophoresis, chromatography or other analysis that provides fingerprint information about the analyte 12, produce better results when the sample has a reasonably high concentration of analytes, and where the analytes are at least slightly separated prior to introduction to the analytical equipment. A large number of analytes may not be satisfactorily resolved by chromatography where many unresolved peaks emerge in a short time. Use of electromobility focusing prior to further analysis improves the accuracy and resolution of these analytical tools. It is also contemplated that electromobility focusing be used following another analytical separation, as where at least some of the analytes from a liquid separation are subsequently processed by electromobility focusing.

The apparatus 10 for simultaneously concentrating and separating a plurality of analytes 12 includes a passageway 12 enclosed to the analytes. When membranes or dialysis fibers 32 are used as in one embodiment of the invention, carrier fluid 16 and small ions 46 pass through the membrane, but larger molecules, such as the analytes 12 cannot pass through it. The carrier fluid 16 including a plurality of the analytes 12 is within the passageway 14.

At least two opposing forces are applied to the fluid 16 to create an equilibrium between the two forces. The continuous electric field gradient is present in the passageway 14 and is characterized by the graph of the field intensity with respect to the position along the length of the axis of the passageway being a non-linear, monotone, non-decreasing function with a non-increasing first derivative. The opposing force acts upon the analytes 12 in a direction opposite the gradient. These forces act on the analytes 12, concentrating and separating them in a specific order according to a property defined by the selection of forces.

The apparatus 10 also includes a means for changing the balance of the forces to elute the separated analyte 12 species from the passageway 14. In the embodiments shown, the analytes 12 are moved from the passageway 14 by increasing the fluid flow, decreasing the electrical field intensity or both. Where an electrical field gradient is used, any method of decreasing the voltage differential, such as a potentiometer, may be used. The hydrodynamic forces are variable by changing settings on one or more pumps 52, opening valves, injecting syringes 54 and the like, to increase the fluid flow. If concentration gradients are established by the ions 46 in the carrier fluid 16, the balance could be changed by increasing or decreasing the concentration of the ions. Changes in acoustic forces could be effected by varying the frequency or amplitude of the sound waves. The means for changing the balance of forces also includes automation, such as controllers or programmed computers, that change the balance of forces by automatically adjusting flow rates, voltage differentials or other appropriate forces.

The following example demonstrates one embodiment of the present invention.

### EXAMPLE

A modified cellulose hollow dialysis fiber 32 was obtained from Membrana (Wuppertal, Germany) with an internal diameter of 200 μm and a dry wall thickness of 8 μm. The molecular weight cutoff of the fiber was 10,000. Untreated fused silica capillary tubing (250 μm I.D.×365 μm O.D. and 535 μm I.D.×693 μm O.D.) was purchased from Polymicro Technologies (phoenix, Ariz.). Model proteins 12, myogloblin (“Mb”) and bovine serum albumin (“BSA”), were obtained from Sigma (St. Louis, Mo.). All other chemicals were analytical grade reagents from Sigma. The buffer solutions 16, 50 were prepared with deionized water from a Millipore water purifier, filtered through a 0.22 μm filter, and degassed with an ultrasonic vibrator before use.

A schematic diagram of the fiber-based system is shown in FIG. 1. A 6 cm long dialysis fiber 32 was connected with two 10 cm lengths of fused silica capillary 60 (250 μm I.D.) at each end. The fiber 32, serving as the gradient channel 42, was then inserted coaxially inside another fused silica capillary (535 μm I.D.) tubing that acted as the purge channel 44, and assembled with other parts of the system using two low pressure crosses 62 and standard low pressure fittings from Upchurch (Oak Harbor, Wash.). A Model PHD2000 syringe pump 52 (Harvard Apparatus, Holliston, Mass.), combined with a 250 μL gas-tight syringe 54 (Hamilton, Reno, Nev.) were used to deliver the sample 12 and high concentration buffer carrier fluid 16 into the fiber 32 (gradient channel 42). A model 55-1199 syringe pump 52 (Harvard Apparatus), combined with a 25 mL gas tight syringe 54 (Hamilton), was used to deliver the low concentration buffer purge solution 50 through the outside fused silica capillary (purge channel 44). The high voltage source 28 was from Spellman (Model CZE 1000R, 30 kV, 300 μA, Hauppage, N.Y.) and a UV-Vis absorption detector with fiber optics detection accessory from ThermoQuest (Model UV3000, Rivera Beach, Fla.) completed the instrumentation.

The high concentration buffer carrier fluid 16 inside the fiber 32 was 100 mM Tris-HCl, pH 8.7, and the low concentration buffer purge fluid 50 was 2 mM Tric-HCl, pH 8.7. The inside fiber 32 flow rate was 0.5 μL/min, which corresponds to a linear velocity of 2.65×10⁻² cm/s, and the outside flow rate was 200 μL/min. The sample 12 was a mixture of 0.5 mg/m/l Mb and 0.5 mg/mL BSA in 100 mM Tris-HCl buffer, pH 8.7. After the sample 12 was injected into the fiber 32, a voltage of 8 kV was applied across the fiber; at 61 minutes, the voltage was decreased to 5 kV, and at 90 minutes, the voltage was decreased to 3 kV. Detection was achieved at 214 nm with a UV absorption detector.

A voltage of 8 kV was applied to electrodes 22 placed at each port 24, 26 of the gradient channel 42. The electric field intensity increased from about 100 V/cm at the entry port 24 to the gradient channel 42 and increased to a maximum of about 700 V/cm at about 0.3 cm. Both BSA 12a and Mb 12b were retained near the entry port 24 and were not resolved. When the voltage was decreased to 5 kV, the maximum value of the electric field intensity gradient, the maximum value of the electric field intensity decreased to about 350 V/cm. BSA 12a was retained in the fiber 32, while Mb 12b eluted out of the fiber. The two proteins were resolved by voltage regulation. When the voltage was decreased to 3 kV, the maximum value of the electric field intensity decreased to about 200 V/cm, and BSA 12a eluted out of the fiber 32.

FIG. 8 shows the experimental results of voltage controlled separation of BSA 12a and Mb 12b. At first, 8 kV was applied across the fiber 32 and both proteins were retained in the fiber. Since BSA 12a has a higher mobility magnitude than Mb 12b, the focusing position of BSA was closer to the entrance of the fiber than that of Mb. Thus the two analytes 12 were stored in the order of mobility, even though the bands were not totally resolved. When the voltage was decreased to 5 kV, Mb 12b could not be focused in the fiber any longer due to its mobility, so it eluted out and was detected by the UV absorption detector. At this voltage, BSA 12a was held inside the fiber 32, although the band became broader. Finally, when the voltage was decreased to 3 kV, BSA 12a also lost its focusing conditions and eluted out. These results clearly show that the proteins 12 were stored in the fiber 32, then eluted sequentially by lowering the voltage.

The embodiments and examples shown herein are intended to exemplify the invention and are not intended to limit it in any way. Features discussed or shown with one particular embodiment are not to be limited to that embodiment. For example, the pump 53 or syringe 54 shown in FIG. 1 are useful not only for the hollow fiber approach, but where the distributed resistor 30 or passageway of FIG. 4 are used to generate the electric field gradient. If different opposing forces are used in place of hydrodynamic forces exemplified here, then equivalent changes would be made to accommodate the different forces, including different control mechanisms, methods of changing the balance of forces and the like. The equipment may be differently arranged, such as the use of a centrifuge to produce centrifugal forces as may be used to generate a density gradient. Additional equivalent embodiments and uses for this invention will be apparent to an artisan in this particular field.

What is claimed is:

1. A method of concentrating and separating, in a specific order, a plurality of analytes, comprising:
generating a continuous electric field gradient within a passageway enclosed with respect to the analytes, the gradient being characterized by the graph of the gradient with respect to position along the length of the axis of the passageway being a non-linear, monotone, non-decreasing function with a non-increasing first derivative;
exposing a carrier fluid, including a plurality of analytes and located within the passageway, simultaneously to the continuous electrical field gradient and an opposing force, the opposing force being selected for exerting a balancing force on at least one of the analytes;
allowing the analytes to approach or reach equilibrium with respect to the continuous electric field gradient and the opposing force; and
automatically releasing the analytes in a controlled manner to maintain separation.

2. The method of claim 1, wherein the opposing force in said exposing step is a centrifugal, gravitational, magnetic, thermal, acoustic, hydrodynamic, electroosmotic or electromagnetic force.

3. The method of claim 1, wherein the opposing force is a combination of forces.

4. The method of claim 1, wherein the continuous gradient of said generating step varies due to the use of at least one of the group consisting of a varying cross sectional area of the passageway, a distributed resistor or a semi-permeable membrane along at least a portion of the passageway.

5. The method of claim 1 further comprising an introducing step comprising injecting the analytes as a fluid or entrained in a carrier fluid, using a syringe, valve or any other fluid dispensing device.

6. The method of claim 1, wherein the carrier fluid comprises a mixture of fluids.

7. The method of claim 6, wherein the carrier fluid includes at least one of polymers and electrolytes.

8. The method of claim 1, wherein the passageway is a microchannel.

9. The method of claim 1, wherein the passageway has an entry port and an exit port and said generating step further comprises applying one of two electrodes having a constant voltage differential to each of the entry port and the exit port.

10. The method of claim 1, wherein said generating step further comprises selecting the slope of the gradient to optimize the degree of concentration and separation of the analytes.

11. The method of claim 9, wherein said releasing step comprises a series of steps whereby each step comprises removing the separated analytes, reducing the voltage differential and allowing the analytes to approach or reach equilibrium with respect to the continuous electric field gradient and the opposing force.

12. The method of claim 9, wherein said releasing step comprises changing the balance between the continuous electric field gradient and the opposing force such that the separated analytes move toward the exit port.

13. The method of clam 1, further comprising automatically controlling at least one of the voltage differential, at least one opposing force and said releasing of the analytes.

14. The method of claim 1 wherein said analytes comprise at least one of proteins, lipoproteins, nucleic acids, peptides and carbohydrates.

15. The method of claim 1 further comprising diagnostic testing utilizing one or more of the separated analytes.

16. The method of claim 1 wherein the source of the analyte is a biological organism.

17. A method of concentrating and separating, in a specific order, a plurality of analytes, comprising:
generating a continuous electric field gradient within a passageway enclosed with respect to the analytes, the gradient being characterized by the graph of the gradient with respect to position along the length of the axis of the passageway being a non-linear, monotone, non-decreasing function with a non-increasing first derivative;
exposing a carrier fluid, including a plurality of analytes and located within the passageway, simultaneously to the continuous electrical field gradient and an opposing force, the opposing force being selected for exerting a balancing force on at least one of the analytes;
allowing the analytes to reach or approach equilibrium with respect to the continuous electric field gradient and the opposing force;
releasing the analytes in a controlled manner to maintain separation; and
determining properties or fingerprint information by further separating, identifying or analyzing at least one of the analytes.

18. The method of claim 17, wherein said determining step utilizes using at least one of chromatography, electrophoresis, mass spectrometry or other means for separating analytes.

19. The method of claim 17, wherein the passageway is packed with particles or monolithic material along at least a portion of its length.

20. A method of concentrating and separating, in a specific order, a plurality of analytes, comprising:
separating at least two of the analytes using a liquid separation;
conducting the analytes directly from the liquid separation to a passageway enclosed with respect to the analytes;
generating a continuous electric field gradient within the passageway, the gradient being characterized by the graph of the gradient with respect to position along the length of the axis of the passageway being a non-linear, monotone, non-decreasing function with a non-increasing first derivative;
exposing a carrier fluid, including a plurality of analytes and located within the passageway, simultaneously to the continuous electrical field gradient and an opposing force, the opposing force being selected for exerting a balancing force on at least one of the analytes;
allowing the analytes to reach equilibrium with respect to the continuous electric field gradient and the opposing force; and
releasing the analytes in a controlled manner to maintain separation.

21. The method of claim 20 wherein said liquid separation is at least one of chromatography, capillary electrophoresis, mass spectrometry or isoelectric focusing.

22. An apparatus for concentrating and separating, in a specific order, a plurality of analytes, comprising:
an enclosed passageway;
a continuous electric field gradient characterized by the graph of said gradient with respect to position along the length of the axis of said passageway being a non-linear, monotone, non-decreasing function with a non-increasing first derivative;
a carrier fluid comprising a plurality of analytes within said passageway;
at least one opposing force acting on said analytes in a direction opposing said gradient that concentrates and separates said analytes when said analytes approach or-reach equilibrium with respect to said gradient and said opposing force; and
a means for automatically changing the equilibrium of said gradient and said opposing force to release said separated analytes in a controlled manner.

23. The apparatus of claim 22, wherein said passageway is packed with particles or monolithic material along at least a portion of its length.

24. The apparatus of claim 22, wherein said passageway is a microchannel.

25. The apparatus of claim 22, comprising a series of passageways operated in a parallel manner.

26. The apparatus of claim 22, wherein said passageway is in contact with a semi-permeable membrane along at least a portion of its length.

27. The apparatus of claim 22, further comprising a computerized control means configured to control at least one of said gradient, said opposing force and injection of a sample including said analytes into said passageway.

28. The apparatus of claim 22, wherein said electric field has a first portion configured for concentrating and ordering said plurality of chemical species and a second portion configured for separating said plurality of chemical species from each other.

29. The device of claim 22 further comprising a control device configured for control of said first continuous field gradient.

30. The device of claim 22, wherein multiple enclosed passageways are operated in parallel.

31. The device of claim 22, wherein multiple enclosed passageways create a microchannel array.

32. The device of claim 22 wherein the passageway has a continuously decreasing cross-sectional area.

33. The device of claim 22 wherein said electric field gradient is created using a distributed resistor.

34. The device of claim 22 wherein said passageway further comprises a gradient channel and a purge channel separated at least in part by a semi-permeable membrane.
